(19) United States
(12) Patent Application Publication
(10) Pub. No.: US 2019/0193090 A1
(43) Pub. Date: Jun. 27, 2019

(54) HOUSING FOR A WET ELECTROSTATIC PRECIPITATOR AND WET ELECTROSTATIC PRECIPITATOR

(71) Applicant: Steuler Korrosionsschutz Holding GmbH, Siershahn (DE)

(72) Inventors: Jürgen Scharkoswki, Mogendorf (DE); Matthias Herzog, Isenburg (DE)

(73) Assignees: Steuler Korrosionsschutz Holding GmbH, Siershahn (DE); Steuler Korrosionsschutz Holding GmbH, Siershahn (DE)

(21) Appl. No.: 16/329,880

(22) PCT Filed: Sep. 7, 2017
(86) PCT No.: PCT/DE2017/100750

§ 371 Date: Mar. 1, 2019

(30) Foreign Application Priority Data
Sep. 8, 2016 (DE) 10 2016 116 854.8

(51) Int. Cl. B03C 3/82; B03C 3/16

(52) U.S. Cl. CPC B03C 3/82; B03C 3/16

(57) ABSTRACT

The invention relates to a housing (1) for a wet electrostatic precipitator (100), comprising an inlet (2) and an outlet (3) for an exhaust gas stream and a base body (4) which is designed as an elongated hollow body, said housing being made of plastic or a plastic-containing material, wherein the inlet (2) and the outlet (3) are spaced apart from one another in the direction of the longitudinal extension of the base body (4). According to the invention, the base body (4) has a plurality of connecting points (5) which are arranged in a distributed manner over the outer periphery of the base body (4) and are designed for securing tie-rod elements or other connecting elements transmitting tensile forces. The invention further relates to a wet electrostatic precipitator (100) having a housing (1) of said type.

### TECHNICAL FIELD

The invention relates to a housing for a wet electrostatic precipitator comprising a main body formed as an elongated hollow body for enclosing precipitation tubes, wherein the main body is made of plastic or a plastic-containing material. The invention further relates to a wet electrostatic precipitator having such a housing.

### BACKGROUND

Wet electrostatic precipitators are technical installations for cleaning exhaust air, exhaust gas or process gases (hereinafter generally referred to as exhaust gas) and are used for separating solid or liquid particles. To this end, the wet electrostatic precipitator uses the effect of an electrical field force on charged particles, which are deposited on a collector electrode and are removed there by means of flushing or free discharge, for example, due to gravitational force.

The wet electrostatic precipitators usually have a plurality of precipitation tubes, through which the exhaust gas to be purified is passed. An electrical field is generated such that when the exhaust gas flows through the precipitation tubes, the particles contained in the exhaust gas are ionized and migrate to the inner wall of the precipitation tubes due to the effect of the electrical field force. Here, the ionized particles together with liquid droplets from the exhaust gas, which flow through the precipitation tubes along the inner wall, are transported to the outside.

The precipitation tubes are usually enclosed in a housing. The housing can be a metal housing. For reasons of costs and corrosion, the housing is now increasingly produced from plastic or plastic-containing material. As a result, however, during the operation of the wet electrostatic precipitator, deformations of the housing can be promoted, which can be caused due to force by the delivery pressure for the exhaust gas within the housing. For normal operation of the wet electrostatic precipitator under vacuum, such deformations are counteracted by producing the housing with a circular cross-section. In this regard, there have been limitations to date on housings made of plastic to those having such a deformation-resistant cross-section.

In addition, the housings usually have enormous overall dimensions, which are caused by the plurality of precipitation tubes used. For example, the housings frequently have a diameter of 4 to 7 meters and a length of 11 to 13 meters. As a result, transportation of the housing is very complex and expensive.

It is, therefore, the aim of the invention to propose at least one possibility to improve wet electrostatic precipitators of the aforementioned type.

### SUMMARY

A standard housing for a wet electrostatic precipitator comprises a main body produced from plastic or a plastic-containing material. The main body can be used for enclosing or accommodating precipitation tubes. For this purpose, the main body is formed as an elongated hollow body. Furthermore, the housing has an inlet and an outlet for an exhaust gas flow, wherein the inlet and the outlet are arranged at a distance from one another in the direction of the longitudinal extension of the main body.

In particular, the main body has a hollow cavity. In particular, the main body has an inner side facing towards the hollow cavity and an outwardly facing outer side, specifically facing away from the inner side. In particular, the housing is configured such that the precipitation tubes are provided with their longitudinal extension in the longitudinal direction of the main body. In particular, the main body comprises a projection, a shoulder or similar step in order for a precipitation tube bundle to be placed against it, for example in that a supporting structure bearing the precipitation tube bundle is supported against it.

The main body comprises a plurality of attachment points, which are arranged over the outer circumference of the main body in a distributed manner and are designed for attaching connecting elements transmitting tensile force and/or compressive force, such as tie-rod elements. In particular, the attachment points are arranged on the outer side.

A measure is thus taken in that the housing, in particular the main body, can be largely or wholly relieved with respect to any effective transverse forces, i.e. forces effective transversely to the longitudinal extension of the main body. This is because owing to the attachment points, a redirection of the transverse forces acting on the housing or the main body to a third object can be realized in a simple manner, said third object receiving the transverse forces and thereby relieving the housing or the main body in terms of force. For this purpose, only those connecting elements transmitting the tensile force and/or compressive force which are supported against the third object or attached thereto have to be attached to the attachment points so that a force is transmitted onto or into the third object via the connecting elements.

Such a third object is, for example, a bearing structure, on which the housing is supported in the direction of its longitudinal extension, which therefore supports the housing. By arranging the attachment points over the circumference of the main body in a distributed manner, one-sided component relief of the housing or the main body can be effectively avoided. This is because the transverse forces can thereby be easily transmitted to the third object, distributed uniformly over the circumference of the main body.

For example, the third object or the bearing structure is arranged outside the housing. For example, the third object at least partially surrounds the housing. In particular, the attachment points are provided for this reason on the outer circumference, i.e. on the outer side of the main body, and the connecting elements transmitting the tensile force and/or compressive force are arranged there. This is also because precipitation tubes and/or precipitation tube bundles are located on the inside of the housing or within the hollow cavity of the main body when the wet electrostatic precipitator is assembled.

It is appropriate that the attachment points are arranged along the longitudinal extension of the main body, in particular arranged in a distributed manner. Component relief can thus be achieved over the length of the main body.

It is further appropriate that a plurality of attachment points are arranged in a distributed manner in a common plane over the outer circumference of the main body and a plurality of such planes are disposed one behind the other in the direction of the longitudinal extension of the main body, in particular offset one behind the other in the direction of the longitudinal extension of the main body. The outer surface of the main body is provided with a network of attachment points in this manner, thus providing the basis for uniformly distributed force transmission to the third object.

In that the housing can be largely or wholly relieved of exerted transverse forces by the invention, the housing or the main body can be produced with any cross-sectional shape, even if the cross-sectional shape is less resistant to deformation. This is because by means of the invention the transverse forces acting on the housing or the main body are redirected so that force transmission into the main body or the housing is completely or at least largely avoided.

In this respect, it is possible for the main body formed as an elongated hollow body to have a polygonal cross-section. A polygonal cross-section is less dimensionally stable than a circular cross-section with respect to transverse forces, but achieves better use of the cross-section. For example, more precipitation tubes can be incorporated by the main body having a polygonal cross-section than by a main body having circular cross-section when the structurally identical precipitation tubes are used in each case. There are therefore technical and, consequently, economical advantages to be gained by the hollow body having a polygonal cross-section in comparison to a hollow body having a circular cross-section.

When, according to an embodiment of the invention, the main body formed as an elongated hollow body has a quadrangular cross-section, this geometry is technically easy to realize. The cross-section can, for example, be rectangular or square. The main body can comprise one, in particular one single, hollow cavity formed as a passage, which has a polygonal cross-section, in particular a quadrangular, for example rectangular or square cross-section. For example, the hollow body is designed as a cylindrical and/or tubular shape. In principle, it is also naturally possible that the main body has a round, in particular circular cross-section.

According to one embodiment, a wall forming the main body is provided and at least one of the attachment points is formed by a receptacle provided in or on the wall for the or a connecting element transmitting tensile force and/or compressive force. For example, the receptacle is a receptacle, in particular a borehole, provided in the wall. The receptacle can be a thread-guiding receptacle, such that the connecting element can be screwed in, particularly screwed in with one end.

A further embodiment consists in that a wall forming the main body is provided and at least one of the attachment points is formed by a reinforcing part which is bonded to the outer side of the wall and to which the or a connecting element transmitting tensile force and/or compressive force can be attached, in particular can be screwed in. In this way, the connecting element can be attached to the attachment point in a technically simple manner. At the same time, a high component strength is provided to the region of the attachment point due to the reinforcing part provided there. The wall can be the wall described above. In this regard, a combination is also possible, wherein individual attachment points are formed by the receptacle provided in or on the wall and in turn another of the attachment points is formed by the reinforcing part bonded to the outer side of the wall or by a reinforcing part which is bonded to the outer side and to which the connecting element can be attached.

The reinforcing part can be a metal profile, in particular a steel profile. The reinforcing part can be laminated to the wall, which is produced from plastic or plastic-containing material, or be bonded by means of another integral and/or thermal bonding technique. In this manner, the reinforcing part can be attached to the wall in a technically simple manner.

A technically simple attachment of the connecting element is achieved if the reinforcing part has an insertion opening for inserting the connecting element. The insertion opening can be or have a threaded hole so that the connecting element can be screwed in.

It is appropriate that the housing, in particular the main body, on its outer circumference or on its outer side comprises an outwardly projecting projection or shoulder or a step having a contact surface in order to be supported against an above-described bearing structure in the axial direction with respect to the longitudinal axis of the housing. The housing can thus be supported in a technically simple manner. Stable support can be achieved if the projection, shoulder or the step is formed peripherally over the circumference. For example, the contact surface lies transversely, in particular orthogonally, relative to the longitudinal axis of the main body.

It is further appropriate that the main body on its inner circumference or its inner side has at least one retainer so that, when the housing is positioned, the precipitation tube bundle can be supported against the housing with precipitation tubes extending in the longitudinal direction. For example, the main body on its inner circumference or its inner side can have an inwardly protruding projection or shoulder or a step having a contact surface so that a precipitation tube or precipitation tube bundle can be placed thereon. For example, the precipitation tube or precipitation tube bundle is thereby supported in the axial direction in relation to the longitudinal axis of the housing on the main body. In this way, support of the precipitation tube or precipitation tube bundle can be achieved in a technically simple manner. Stable support can be achieved if the projection, shoulder or the step is formed peripherally over the circumference. For example, the contact surface lies transversely, in particular orthogonally, relative to the longitudinal axis of the main body.

According to a possible embodiment or independent aspect of the invention, a housing is provided for a wet electrostatic precipitator, which comprises a main body which is produced from plastic or a plastic-containing material. The main body can be used for enclosing or accommodating precipitation tubes. For this purpose, the main body is formed as an elongated hollow body. Furthermore, the housing has an inlet and an outlet for an exhaust gas flow, wherein the inlet and the outlet are arranged at a distance from one another in the direction of the longitudinal extension of the main body. The housing can be the housing as described above.

The main body is built in a modular manner, comprising at least two, preferably a plurality of wall parts, in particular separate wall parts, of which adjacent wall parts are each connected to one another to form at least a part of the inner circumference of the main body. In this respect, the wall parts are longitudinal parts of the main body.

This measure is based on the concept of dividing the housing or the main body into individual modules according to the concept of modularity. Volumetrically, these modules should be preferably dimensioned such that the modules can be transported in a simple manner. For example, the modules should be volumetrically dimensioned such that they are a standardized size for transportation. The modular structure of the housing or main body thereby provides advantages in respect of transportation and storage. Owing to the disassembly of the main body, compression of the volume is easily achieved since the previous diameters of 4 to 7 meters are thus avoided. Owing to the lower volume and the smaller transportation units, there are also packaging advantages.

The module structure of the housing or the main body is particularly advantageous if the housing has the above-described attachment points for the connecting elements transmitting the tensile force and/or compressive force. Thus, the housing is protected with respect to load since any transverse forces arising during the operation of the wet electrostatic precipitator are directed to a or the third object via the attachment points and the connecting elements transmitting the tensile force and/or compressive force. Specific component weakening of the housing can be permitted on account of the modular structure.

According to an embodiment, in the case of a square cross-section of the main body, the wall parts are formed by two types of identical parts, of which one type of the wall parts forms a section of the inner circumference of the main body with a corner region and the other type of the wall parts forms a section of the inner circumference of the main body without a corner region, in particular a rectilinear section of the inner circumference. By means of the identical parts, cost-effective production can be realized since only two types of wall parts are required for the assembly of the housing or main body. The assembly of the main body is also made easier since the fitter only has a small selection of different components. In addition, the wall parts without a corner region have a geometry which is technically easy to realize, in particular if the wall parts form a rectilinear section of the inner circumference.

The wall parts can be connected to one another in an integrally bonded manner. For example, the wall parts are connected to one another by means of welding, in particular by using thermal energy and/or mechanical energy. For example, the wall parts are connected to one another by means of friction welding, heat element butt welding and/or fusion welding. The wall parts are thus technically simple and cost-effective to produce. Any connecting means or separate connecting means for connecting the wall parts to one another can be spared where appropriate, for example by welding the wall parts together without additional welding means, in particular by welding together edge to edge.

According to a further embodiment, the wall parts can be connected or are connected to one another by means of connecting means, in particular detachably connected, for example are connected or are connectable to one another in a force-fitting and/or form-fitting manner. In this way, it is possible for the wall parts to be produced in the factory in a simple assembly technique and for the wall parts to be assembled into the housing, for example, by the customer and/or on the building site by a fitter. Individual wall parts can also be replaced on site in a simple assembly technique if the housing is already assembled since it can be dismantled into its components again.

For example, the connecting means are provided for such wall parts which consist of a non-weldable plastic or contain such a plastic. The non-weldable plastic is, for example, a Teflon material or a high-molecular plastic. Using the connecting means, such materials can be used in the module-based concept which are not considered when wall parts are connected by means of welding.

It is also possible for the wall parts, in particular adjacent wall parts, to be connected or connectable in a non-detachable manner using the connecting means. Such a non-detachable connection can be realized by means of an integral bond, for example, by welding, soldering and/or adhesion of the wall parts to one another.

It is advisable for the connecting means to be formed on the wall parts, in particular integrally formed. Thus, the connecting means can be realized in a technically simple manner since they are produced during the production of the wall parts. Simplification is also achieved when assembling the wall parts since the fitter has the connecting means directly on the wall parts and in this respect does not need to resort to separate connecting means.

For example, the connecting means form a plug connector. In this respect, it is possible according to an embodiment of the invention for the adjacent wall parts, in particular each of the adjacent wall parts, to be connected to one another to form a plug connector.

It is advisable for the adjacent wall parts, in particular each of the adjacent wall parts, to be fitted together in the circumferential direction with respect to the housing. The cohesion of the plug connector is thus facilitated by a vacuum prevailing in the main body. This is because a force acts in the direction towards the center of the main body by means of the vacuum.

To form the plug connector, a push-in receptacle is provided, in particular integrally formed, on one of the adjacent wall parts, and a push-in element that can be pushed into the push-in receptacle is provided, in particular integrally formed, on the other of the adjacent wall parts.

To be able to produce a plug connector with the respectively adjacent wall part in each case, it is advisable for each of the wall parts to have two coupling sections in order to form the plug connector with each of the adjacent wall parts. The coupling sections on a wall part can be similar so that both coupling sections are each formed as a push-in receptacle or push-in section on the one wall part. The coupling sections can also be formed, conversely, on a wall part so that one coupling section is formed by a push-in receptacle and the other coupling section is formed by a push-in section.

It is advisable for at least one of the attachment points for the or a connecting element transmitting tensile force and/or compressive force to be provided on each of the wall parts. This ensures that each of the wall parts forming the main body is largely or wholly relieved in terms of any effective transverse forces.

According to a further aspect of the invention, a wall part is provided for a housing of a wet electrostatic precipitator. The wall part can comprise the features of the wall part described in relation to the above-described housing. The wall part is produced from plastic or a plastic-containing material and forms a circumferential section of the inner circumference of a main body of the housing, in particular of the above-described main body. Furthermore, the wall part can be connected to at least one further wall part to form at least one part of the inner circumference of the housing.

It is advisable for the wall part to have at least one, preferably a plurality, of attachment points for a connecting element transmitting tensile force and/or compressive force. The attachment points can be the attachment points described above. This ensures that in the assembled state with respect to the housing or main body, the wall part is largely or wholly relieved in terms of any effective transverse forces.

It is further advisable for the wall part to comprise at least one coupling section in order to form a plug connector with a counter-coupling section of the other wall part. The coupling section and counter-coupling section can be the above-described coupling section and counter-coupling section.

According to a further aspect of the invention, a wet electrostatic precipitator is provided. The wet electrostatic precipitator comprises a housing for carrying an exhaust gas flow and a supporting structure or bearing structure at least partially surrounding the housing, wherein the supporting structure or bearing structure is erectable or erected on a base surface. The housing can be the housing as described above. The housing has a main body which is formed as an elongated hollow body and is produced from plastic or a plastic-containing material and can be used for enclosing or accommodating precipitation tubes. Furthermore, the housing has an inlet and an outlet for the exhaust gas flow, wherein the inlet and the outlet are arranged at a distance from one another in the direction of the longitudinal extension of the main body.

The main body comprises a plurality of attachment points, which are arranged in a distributed manner over the outer circumference of the main body, and transversely to the longitudinal extension of the main body at least one connecting element, for example a tie-rod element, transmitting tensile force and/or compressive force is bonded, in particular attached, in each case on one side to said attachment points, and is bonded, in particular attached, on the other side to the bearing structure, such that transverse forces acting transversely to the longitudinal extension of the main body are absorbed by the bearing structure. In particular, a connecting element protrudes outwards from the main body.

Thus, the housing, in particular the main body, is largely or wholly relieved with respect to any effective transverse forces, i.e. forces acting transversely to the longitudinal extension of the main body. This is because, owing to the attachment points and the connecting elements, the transverse forces acting on the housing or the main body are redirected to the supporting structure, which receives the transverse forces and thereby relieves the housing or the main body in terms of force.

According to an embodiment, the connecting element is a joint-free and dimensionally stable rod member, for example a threaded rod, which is firmly bonded with its one end against the main body and with its other end against the bearing structure at least in the direction of its longitudinal axis. The connecting element is thereby produced in a technically simple and cost-effective manner.

According to another embodiment, it is possible for the connecting element to be a pendulum element which comprises at least two joints and which permits a change in the position of the associated attachment point of the main body in relation to the associated attachment position on the bearing structure in the direction of the longitudinal extension of the main body. Such a pendulum element can be a so-called multi jointed rod, in particular a double-jointed rod.

The longitudinal section arranged between the joints can be formed by a flexible cable element that is tensioned in the longitudinal direction. Alternatively, the longitudinal section arranged between the joints can also be formed by a dimensionally stable, rigid rod member.

A stable unit can be produced in a technically simple manner if, according to an embodiment of the invention, at least two of the attachment points each form a unit with the associated tie-rod elements or connecting elements which are attached at the ends against a common profile with interposition of a support of the bearing structure. The profile can be a plate-shaped profile.

It is advisable for the bearing structure to be a steel structure or a reinforced concrete structure. A sufficiently stable bearing structure is achieved in this manner. The bearing structure can comprise, in particular pipelines and/or operating platforms and/or ladders, steps and/or other complementary devices for the wet electrostatic precipitator. For example, the bearing structure is formed as a frame.

It is further advisable for the bearing structure to have a projection, shoulder or similar step, against which the housing is supported in the direction of its longitudinal extension. For example, the projection, shoulder or the step is formed peripherally over the inner circumference of the bearing structure.

In addition, it is advisable for at least one precipitation tube bundle to be incorporated in the main body, the precipitation tubes of said precipitation tube bundle extending with their longitudinal extension in the longitudinal direction of the main body.

The main body, which is produced from plastic or a plastic-containing material, can consist of a glass-fiber-reinforced plastic, also known as GFRP, or comprises such a plastic. In particular, the main body can consist of a thermoplastic material, such as polyethylene (PE) for example, or comprise such a material. The main body can also have a thermoplastic coating or a protective layer made of or with glass-fiber-reinforced plastic on its inner circumference and/or on its outer circumference. The main body can also consist of a non-weldable plastic, such as a Teflon material or a high-molecular plastic, for example, or comprise such a material. If the base body is formed in a modular manner by means of a plurality of wall parts, the wall parts can be formed in the same way with these materials.

Further details and features of the invention arise from the following description of a number of exemplary embodiments on the basis of the drawings.

### BRIEF DESCRIPTION OF THE DRAWINGS

FIG. 1 shows a possible embodiment of a wet electrostatic precipitator in a longitudinal section.

FIG. 2 shows the wet electrostatic precipitator of FIG. 1 in a sectional view along the line of intersection A-A of FIG. 1.

FIG. 3 shows a region of the wet electrostatic precipitator of FIGS. 1 and 2 having a plug connector of two wall parts of the housing of the wet electrostatic precipitator and an anchorage against a bearing structure on the basis of the detail Y of FIG. 2 in a magnified view.

FIG. 4 shows a region of the wet electrostatic precipitator of FIGS. 1 and 2 having an anchorage unit for connecting the housing of the wet electrostatic precipitator to a bearing structure on the basis of the detail X of FIG. 1 in a magnified view.

FIG. 5 shows an alternative anchorage unit for connecting the housing of the wet electrostatic precipitator to the bearing structure.

FIG. 6 shows an embodiment of a wet electrostatic precipitator having a housing and a precipitation tube bundle incorporated therein in a sectional view.

FIG. 7 shows a further embodiment of a wet electrostatic precipitator having a housing and two precipitation tube bundles incorporated therein in a sectional view.

FIG. 8 shows another embodiment of a wet electrostatic precipitator having a housing and four precipitation tube bundles incorporated therein in a sectional view.

FIG. 9 shows another embodiment of a wet electrostatic precipitator having a housing and six precipitation tube bundles incorporated therein in a sectional view.

### DETAILED DESCRIPTION

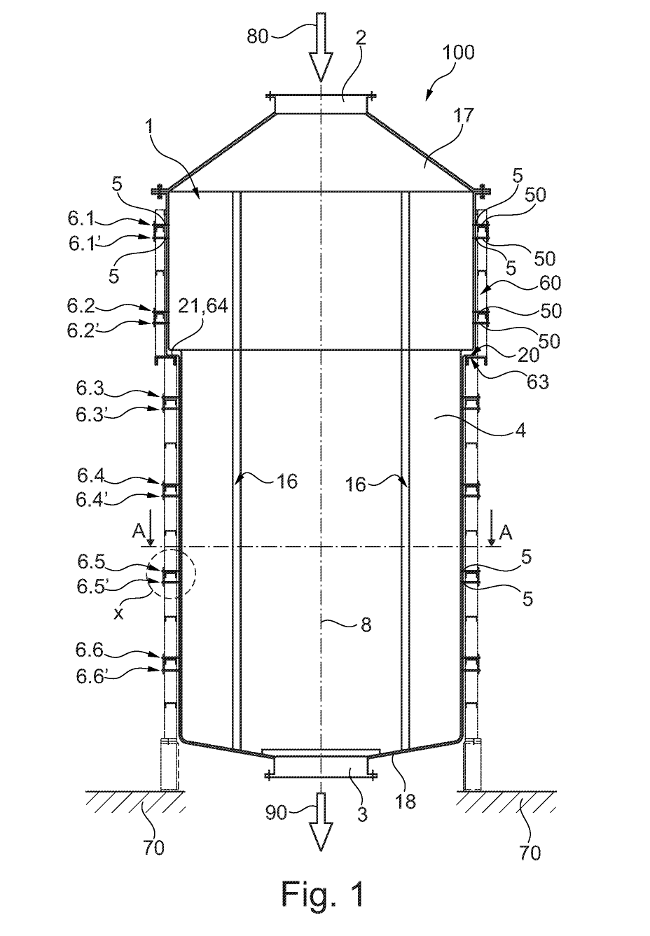

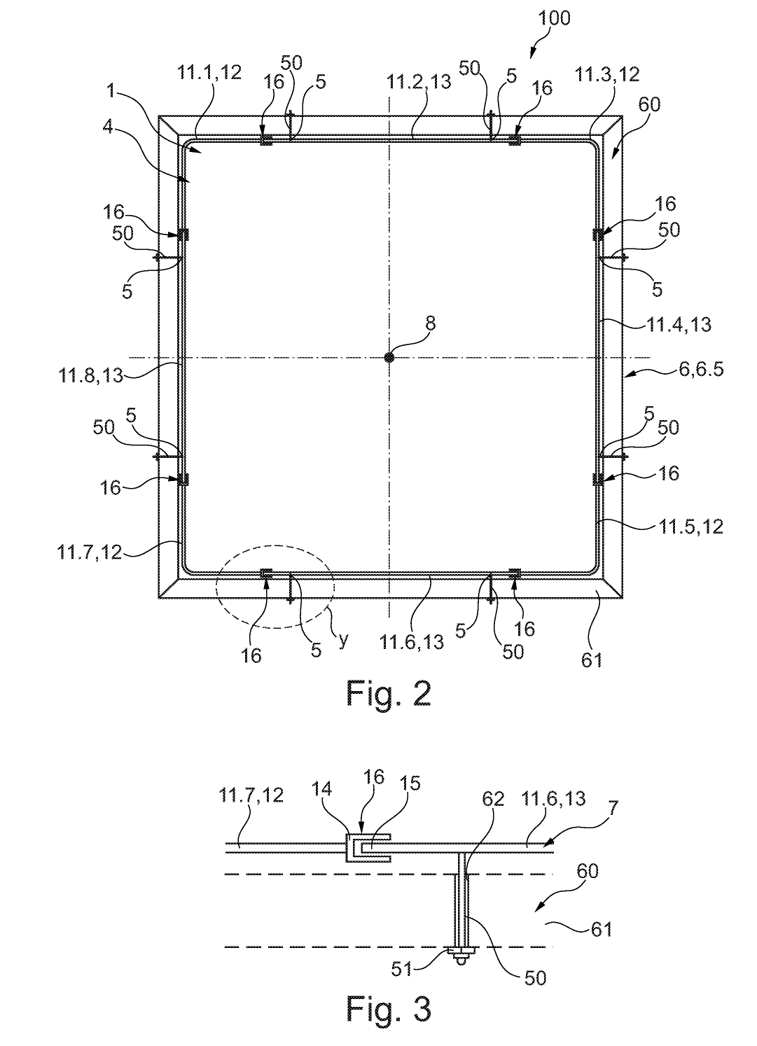

FIGS. 1 and 2 show—in a schematic representation—a possible embodiment of a wet electrostatic precipitator 100 in a longitudinal section along the longitudinal axis 8 of the wet electrostatic precipitator (FIG. 1) and in a cross-section along the line of intersection A-A (FIG. 2). The wet electrostatic precipitator 100 comprises a housing 1 for conducting an exhaust gas flow and a supporting structure 60 which at least partially surrounds the housing 1 and is constructed on a base surface 70, in particular is anchored against the base surface 70. The longitudinal axis 8 of the housing 1 forms a vertical axis in this respect.

The housing 1 has an inlet 2 and an outlet 3 in order to be able to conduct an exhaust gas flow through the housing 1. The inlet 2 is preferably arranged in an upper region of the housing 1 and the outlet 3 in a lower region of the housing 1. The exhaust gas flow is thus directed in the direction of the arrows 80, 90 through the housing 1, i.e. flows through the housing 1 from top to bottom. In principle, the exhaust gas flow can also flow through the wet electrostatic precipitator 100 in the opposite direction. The inlet 2 is then used as the outlet, and the outlet 3 is used as the inlet so that the exhaust gas flow flows through the housing 1 from bottom to top.

The housing 1 is preferably a plastic housing and has an elongated main body 4, which is produced from plastic or a plastic-containing material. For example, the main body 4 is formed from a glass-fiber-reinforced plastic. The housing 1 can have a chemical protective layer on its outer side and/or its inner side, which, for example, has a glass-fiber-reinforced plastic or consists thereof.

The main body 4 is designed as a hollow body having a hollow cavity, in particular a single hollow cavity, and can be used for enclosing at least one (not shown in FIGS. 1 and 2) precipitation tube bundle. For example, the main body 4 is designed to be rotationally symmetrical in relation to the longitudinal axis 8 of the housing 1. Preferably, the hollow cavity of the main body 4 is also designed to be rotationally symmetrical in relation to the longitudinal axis 8, wherein the longitudinal axis 8 preferably coincides with the longitudinal axis of the hollow cavity.

It is possible for the main body 4 to be open at an end side extending in the longitudinal direction of the main body 4 in order to be able to introduce at least one precipitation tube bundle into the hollow cavity of the main body 4. To close this opening, an end piece 17 or end part can be provided, which is, for example, connected, in particular detachably connected, by means of separate connecting means to the main body 4. The end piece 17 is preferably produced from plastic or a plastic-containing material. For example, the end piece 17 is identical to the main body 4 in terms of material.

The end piece 17 is preferably arranged on the upper end of the main body 4 so that the (not shown in FIGS. 1 and 2) at least one precipitation tube bundle can be introduced when the housing 1 is positioned. The inlet 2 of the wet electrostatic precipitator 100 is preferably associated with the end piece 17 and is disposed, for example, in the upper end region of the end piece 17.

The end section provided at the other end of the housing 1 is preferably formed by the main body 4, for example, in that the main body 4 at the lower end has a bottom section 18, which delimits the hollow cavity of the main body 4 towards the lower end. The outlet 3 is preferably associated with the bottom section 18 and can be formed on the lower end of the bottom section 18.

The bearing structure 60 is, for example, a steel or steel-reinforced concrete frame. The bearing structure 60 preferably has a projection, shoulder or similar step 63, which forms a contact surface 64 positioned transversely to the longitudinal axis 8. The step 63 can be formed in a circumferential manner.

The main body 4, in a corresponding manner, preferably has a projection, shoulder or similar step 20, which forms a counter-contact surface 21. The step 20 is preferably formed in a circumferential manner. In the installed state, the housing 1 is fitted on the step 63 of the bearing structure 60 so that forces acting in the longitudinal direction of the housing 1, i.e. in the direction of the longitudinal axis 8 of the wet electrostatic precipitator 100, are absorbed by the bearing structure 60. For example, it is guaranteed in this way that by means of the steps 63 and 20 at least the weight force of the housing 1 with the weight force of the components accommodated therein or attached thereto are absorbed by the bearing structure 60 in that the step 20 is supported against the step 63.

The main body 4 comprises a plurality of attachment points 5, which are arranged in a distributed manner over the outer circumference of the main body 4, as can be seen in particular from FIG. 2. The attachment points 5 are also preferably arranged in the longitudinal extension of the main body 4, as can be seen from FIG. 1. Advantageously, a plurality of the attachment points 5 are arranged in a distributed manner in a common plane 6 over the circumference of the main body 4 and a plurality of such planes 6.1, 6.1′, 6.2, 6.2′, 6.3, 6.3′, 6.4, 6.4′, 6.5, 6.5′, 6.6, 6.6′ are arranged one behind the other in the longitudinal extension of the main body 4.

At least one connecting element 50 transmitting tensile force and/or compressive force, for example a tie-rod element, is bonded in each case to the attachment points 5, wherein any effective transverse forces, i.e. acting transversely to the longitudinal axis 8, are transmitted via said connecting element to the bearing structure 60. The transverse forces are therefore introduced into the bearing structure 60 and the main body 4 is thereby relieved. The transverse forces are, for example, brought about by the delivery pressure, with which the exhaust gas is delivered into the housing 1. In normal operation with a vacuum, such transverse forces occur which act in an inward direction, causing the housing 1 to deform inwardly or to collapse inwardly.

By introducing possible transverse forces into the bearing structure 60, cross-sectional shapes can be used for the housing 1, which are more sensitive to deformation with respect to transverse forces than, for example, a circular cross-section is. Therefore, the housing 1 has, for example, an angular cross-section, in particular a quadrangular cross-section.

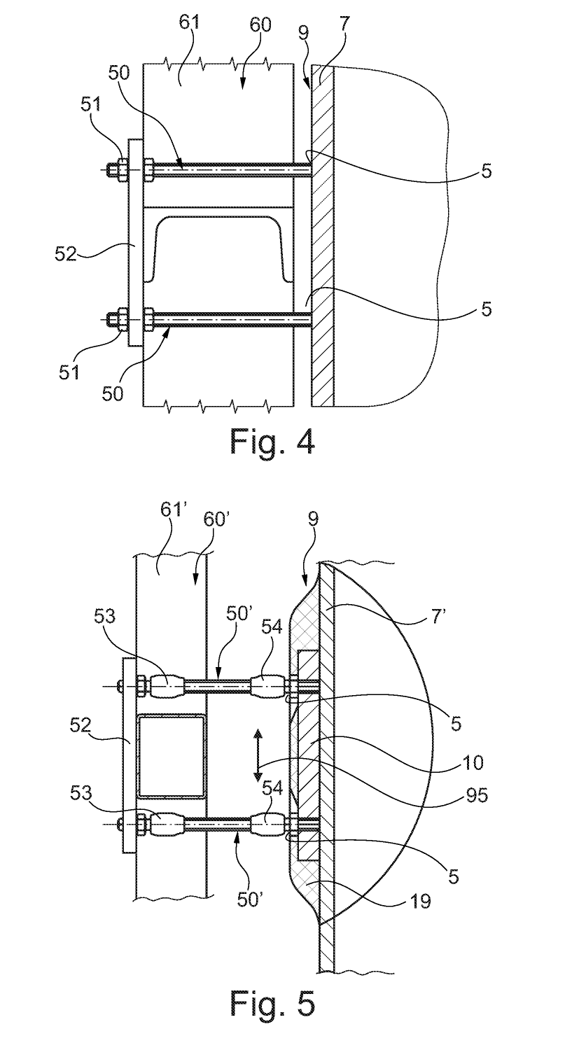

FIGS. 3 and 4 show the structure of the connection between the main body 4 and the bearing structure 60 with the example of one or two of the connecting elements 50 on the basis of the details X and Y of FIGS. 1 and 2. The connecting element 50 can be a rod member which is firmly bonded with its one end against the main body 4 and with its other end against the bearing structure 60, in particular a support 61 of the bearing structure 60. For example, the rod member at least at its end facing the bearing structure 60 has a thread so that attachment with respect to the bearing structure 60 can occur by screwing directly against the bearing structure 60 or the support 61 of the bearing structure 60 or indirectly by means of a nut element 51 with interposition of the bearing structure 60 or the support 61. The bearing structure 60 or the support 61 preferably has a passage opening 62 or a passage borehole, through which the connecting element 50 is inserted and is then screwed at the end using the nut element 51. The connecting element 50 formed as a rod member in this case is, for example, a joint-free and dimensionally stable rod member, which can transmit tensile forces.

As can be seen in particular from FIG. 4, at least two attachment points 5 can form a unit with the associated connecting elements 50 in each case, which are attached at the end against a common profile 52, such as a plate profile, with interposition of the bearing structure 60, in particular of the support 61. The connecting elements 50 with their end facing the main body 4 can be embedded on a wall 7 of the main body 4 in a receptacle provided there in each case. The receptacle can be thread-guiding so that the connecting element 50 with its end, which is also thread-guiding, is screwed into the receptacle.

FIG. 5 shows, in an example, an alternative embodiment of the attachment points 5 of the main body 4. The attachment points 5 there are formed by a reinforcing part 10 which is bonded to the outer side 9 of a wall 7′ of the main body 4 and to which the connecting element 50 or an alternative connecting element 50′ transmitting tensile force and/or compressive force can be attached. The reinforcing part 10 can be a metal profile, such as a steel profile. The reinforcing part 10 is preferably laminated to the wall 7′ by means of a plastic material, which forms an enclosure 19 receiving the reinforcing part 10, said enclosure being connected to the wall 7′ of the main body 4, in particular integrally formed thereon.

In FIG. 5, in contrast to the bearing structure 60 of FIG. 4, a bearing structure 60′ is provided which comprises at least one support 61′ having a closed cross-sectional profile. The closed cross-sectional profile can be a quadrangular profile in its cross-section. In contrast, the bearing structure 60 of FIGS. 1 to 4 has, for example, at least one support, in particular the support 61, which is formed by a profile open at one end, for example a U-shaped profile.

In the embodiment of FIG. 5, the alternative connecting elements 50′ are also provided, which differ from the connecting elements 50 of FIGS. 1 to 4 in that the connecting elements 50′ are formed as pendulum elements having at least two joints 53, 54. As a result, a change in the position of the associated attachment point 5 of the main body 4 in relation to the associated attachment position on the bearing structure 60′ is permitted in the direction of the longitudinal extension of the main body 4, i.e. in the direction of the longitudinal axis 8, as can be seen by the double-headed arrow 95.

In the case of the housing 1, the main body 4 is structured in a modular manner. To this end, the main body 4 has a plurality of wall parts 11.1, 11.2, 11.3, 11.4, 11.5, 11.6, 11.7, 11.8, of which adjacent wall parts 11.1, 11.2 or 11.2, 11.3 or 11.3, 11.4 or 11.5, 11.6 or 11.6, 11.7 or 11.7, 11.8 or 11.8, 11.1 in each case are connected to one another to form at least one part of the inner circumference of the main body 4, as can be seen for example in FIGS. 2 and 3.

Advantageously, the adjacent wall parts 11.1, 11.2 or 11.2, 11.3 or 11.3, 11.4 or 11.5, 11.6 or 11.6, 11.7 or 11.7, 11.8 or 11.8, 11.1 are each connected to one another to form a plug connector 16. The plug connectors 16 are each formed by a coupling section 14 and a counter-coupling section 15, which can be plugged together. For example, the coupling section 14 is formed by a push-in receptacle and the coupling section 15 by a push-in section that can be pushed into the push-in receptacle. Preferably, the coupling section 14 and the counter-coupling section 15 are each integrally formed on the associated wall part 11.6 or 11.7.

Preferably, the wall parts 11.1, 11.2, 11.3, 11.4, 11.5, 11.6, 11.7, 11.8 are formed by two types of identical parts, of which one type of the wall parts 12 forms a section of the inner circumference of the main body 4 with a corner region and the other type of the wall parts 13 forms a section of the inner circumference of the main body 4 without a corner region, for example with a rectilinear section of the inner circumference (FIG. 2).

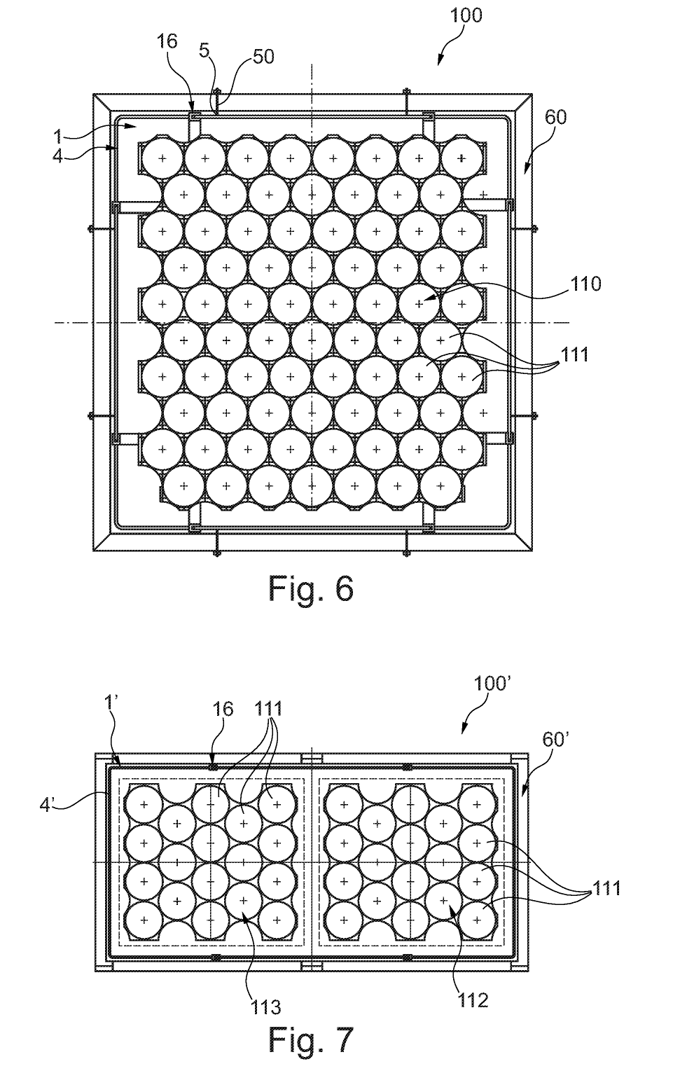

FIG. 6 shows, for example, the housing 1 of the wet electrostatic precipitator 100 with a precipitation tube bundle 110 accommodated therein in a sectional view along the line of intersection A-A of FIG. 1. Preferably, the precipitation tube bundle 110 has a plurality of precipitation tubes 111, which are assembled into a bundle and are held together in the bundle. For example, the precipitation tube bundle 110 forms a quadrangular, in particular rectangular or square cross-section. Preferably, the precipitation tube bundle 110 is positioned on the shoulder 20 of the main body 4, for example by a supporting structure supporting the precipitation tube bundle 110 (FIG. 1) so that the weight force of the precipitation tube bundle 110 is also absorbed by the bearing structure 60 by means of the step 20.

FIG. 7 shows a further embodiment of a wet electrostatic precipitator 100′ having a housing 1′, comprising a main body 4′ having a rectangular cross-section. Two precipitation tube bundles 111 and 112 are incorporated therein. A bearing structure 60′ surrounding the wet electrostatic precipitator 100′ is provided, which is adapted to the cross-sectional dimension of the housing 1′ or of the main body 4′.

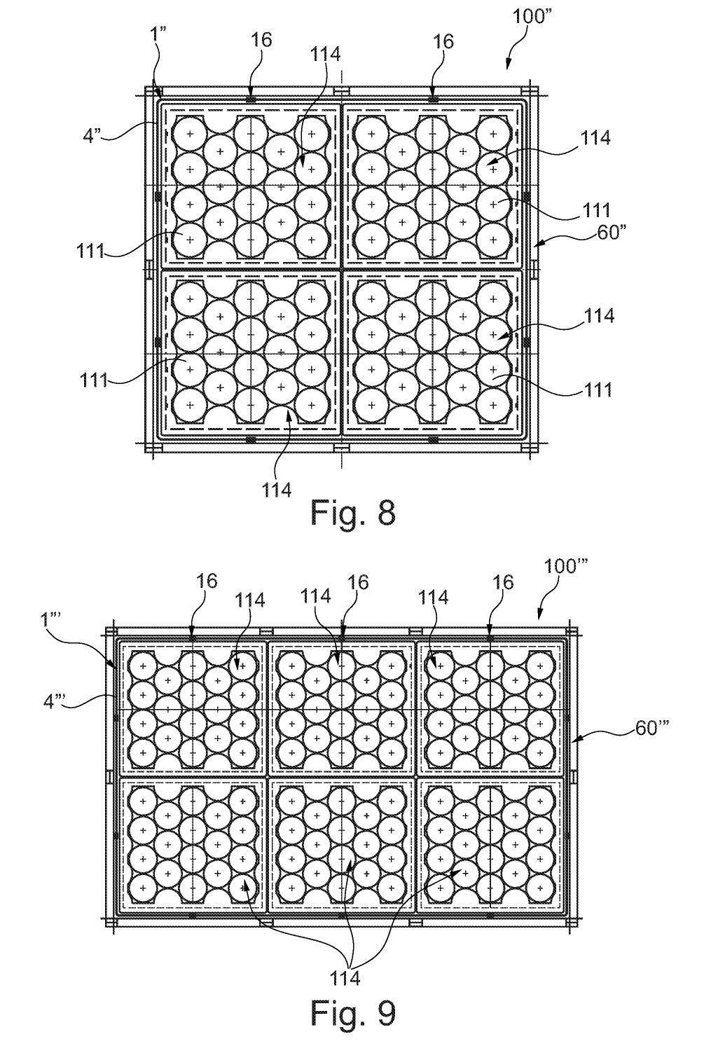

FIGS. 8 and 9 show, for example, further embodiments of a wet electrostatic precipitator 100″ and 100′″ having a housing 1″ or 1′″ , comprising a main body 4″ or 4′″ having a rectangular cross-section. Four precipitation tube bundles 114 (FIG. 8) or six precipitation tube bundles 114 (FIG. 9) are incorporated therein. A bearing structure 60″ or 60′ surrounding the wet electrostatic precipitator 100″ or 100′″ is provided, which is adapted to the cross-sectional dimension of the housing 1″ or 1′ or of the main body 4″ or 4′″.

In principle, the cross-section can assume any form. In this respect, any number of precipitation tube bundles 111 can be incorporated therein.

In the present description, reference to a specific aspect or specific embodiment or specific design means that a specific feature or a specific property described in relation to the aspect or embodiment or design is contained at least therein, but is not necessarily contained in all aspects or embodiments or designs of the invention. It should be explicitly noted that any combination of different features and/or structures and/or properties which are described in relation to the invention are included by the invention if this is not explicitly or clearly contradicted by the context.

The use of individual or all examples or an exemplary expression in the text is used only to highlight the invention and does not constitute any restriction in terms of the scope of the invention if no mention to the contrary is made. Any expression or formulation of the description should be understood such that it relates to a claimed element which, however, is essential for carrying out the invention.

### LIST OF REFERENCE SIGNS

### 1 Housing

### 1′ Housing

### 1″ Housing

### 1′″ Housing

### 2 Inlet

### 3 Outlet

4 Main body
4′ Main body
4″ Main body
4′″ Main body
5 Attachment points

### 6 Plane

### 6.1 Plane

### 6.1′ Plane

### 6.2 Plane

### 6.2′ Plane

### 6.3 Plane

### 6.3′ Plane

### 6.4 Plane

### 6.4′ Plane

### 6.5 Plane

### 6.5′ Plane

### 6.6 Plane

### 6.6′ Plane

### 7 Wall

### 7′ Wall

8 Longitudinal axis
9 Outer side
10 Reinforcing part
11.1 Wall part
11.2 Wall part
11.3 Wall part
11.4 Wall part
11.5 Wall part
11.6 Wall part
11.7 Wall part
11.8 Wall part
12 Wall parts
13 Wall parts
14 Coupling section
15 Counter-coupling section
16 Plug connector
17 End piece
18 Bottom section

### 19 Enclosure

### 20 Step

21 Counter-contact surface
50 Connecting element
50′ Connecting element
51 Nut element

### ↑Profile

### 53 Joint

### 54 Joint

60 Bearing structure
60′ Bearing structure

### 61 Support

### 61′ Support

62 Passage opening

### 63 Step

64 Contact surface
70 Base surface

### 80 Arrow

### 90 Arrow

95 Double-headed arrow
100 Wet electrostatic precipitator
100′ Wet electrostatic precipitator
100″ Wet electrostatic precipitator
100′″ Wet electrostatic precipitator
110 Precipitation tube bundle
111 Precipitation tubes
112 Precipitation tube bundle
113 Precipitation tube bundle
114 Precipitation tube bundle

1.-22. (canceled)

23. A housing for a wet electrostatic precipitator, comprising:
an inlet and an outlet for an exhaust gas flow; and
a main body in form of an elongated hollow body for enclosing precipitation tubes,
wherein the inlet and the outlet are arranged at a distance from one another in the direction of a longitudinal extension of the main body and
wherein the main body
is produced from plastic or a plastic-containing material,
has a polygonal cross-section,
and comprises a plurality of attachment points, which are arranged on sides of the polygonal cross section distributed over an outer circumference of the main body on an outer side of the main body and are designed for attaching connecting elements transmitting tensile force and/or compressive force, to transfer transverse forces acting transversely to the longitudinal extension of the main body through the connecting elements to a third object outside the housing.

24. The housing according to claim 23, wherein the attachment points are arranged in the longitudinal extension of the main body.

25. The housing according to claim 23,
wherein a plurality of the attachment points are arranged in a distributed manner in a common plane over a circumference of the main body and
a plurality of such common planes are arranged one behind another in the direction of the longitudinal extension of the main body.

26. The housing according to claim 23, wherein the main body formed as an elongated hollow body has a quadrangular cross-section.

27. The housing according to claim 23, wherein a wall forming the main body is provided and at least one of the attachment points is formed by a receptacle provided in or on the wall for a connecting element transmitting tensile force and/or compressive force.

28. The housing according to claim 23, wherein a wall forming the main body is provided and at least one of the attachment points comprises a reinforcing part which is bonded to an outer side of the wall and to which one of the connecting elements transmitting tensile force and/or compressive force can be attached.

29. The housing according to claim 28, wherein the reinforcing part is a metal profile and is laminated to the wall or bonded to the wall by another integral bonding technique.

30. The housing according to claim 23, wherein the main body has a modular structure, in that the main body comprises at least two wall parts of which adjacent wall parts are each connected to one another to form at least one part of an inner circumference of the main body.

31. The housing according to claim 30, wherein the wall parts are
formed by two types of identical parts, of which
one type of the wall parts forms a section of the inner circumference of the main body with a corner region and
the other type of the wall parts forms a section of the inner circumference of the main body without a corner region.

32. The housing according to one of claim 30, wherein the adjacent wall parts are connected to one another to form a plug connector.

33. The housing according to one of claim 30, wherein the adjacent wall parts are fitted together in the circumferential direction in relation to the housing.

34. A wet electrostatic precipitator, comprising:
the housing as in claim 23 for conducting an exhaust gas flow; and
a bearing structure which at least partially surrounds the housing and can be placed on a base surface or is placed thereon,
wherein transversely to the longitudinal extension of the main body of the housing at least one connecting element transmitting tensile force and/or compressive force is bonded on one side in each case at the attachment points of the main body and is bonded on the other side to the bearing structure so that transverse forces acting transversely to the longitudinal extension of the main body are absorbed by the bearing structure.

35. The wet electrostatic precipitator according to claim 34,
wherein the at least one connecting element is a joint-free and dimensionally stable rod member, which is firmly bonded with one end thereof against the main body and with another end thereof against the bearing structure at least in the direction of its longitudinal axis.

36. The wet electrostatic precipitator according to claim 34,
wherein the at least one connecting element is a pendulum element which comprises at least two joints by which a change in a position of the associated attachment point of the main body in relation to an associated attachment position on the bearing structure in the direction of the longitudinal extension of the main body is permitted.

37. The wet electrostatic precipitator according to claim 34,
wherein in each case at least two of the attachment points form a unit with the associated connecting elements, which are attached at an end against a common profile with interposition of a support of the bearing structure.

38. The wet electrostatic precipitator according to claim 34, wherein the bearing structure is a steel structure or a reinforced concrete structure.

39. The wet electrostatic precipitator according to claim 34, wherein the bearing structure has a projection, shoulder, or similar step, against which the housing is supported in the direction of the longitudinal extension thereof.

40. The wet electrostatic precipitator according to claim 34, wherein the main body accommodates at least one precipitation tube bundle, the precipitation tubes of which extend with the longitudinal extension thereof in the longitudinal direction of the main body.
